(19) United States
(12) Patent Application Publication
(10) Pub. No.: US 2008/0256168 A1
(43) Pub. Date: Oct. 16, 2008

(54) Target Class Addressing of Updates in Ambient Databases

(75) Inventor: Wilhelmus Franciscus Johannes Fontijin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,997

(22) PCT Filed: Sep. 11, 2006
(86) PCT No.: PCT/IB2006/053197

§ 371 Date: Mar. 25, 2008

(30) Foreign Application Priority Data
Sep. 29, 2005 (EP) 05109001.7

(51) Int. Cl. G06F 15/16

(52) U.S. Cl. 709/201

(57) ABSTRACT

The present invention relates to a method and system of distributing data (108) to a target node (107) in a network (100), said target node being arranged to be disconnectable from the network, A basic idea of the invention is to transfer data to a network target node, which is arranged to be disconnectable from the network, without having to directly address the target node or flood the network with the data by employing broadcast-type transmission. When a network source node (101) wishes to transfer data to a target node, which at the time of data transfer is disconnected from the network, the source node distributes the data to network nodes (104, 105, 106) via which the target node is connectable to the network. When the source node distributes the data to the network nodes via which the target node is connectable to the network, the data is held at these nodes until the target node connects to any one of them. When the target node connects to any one of these nodes, the particular node with which the target node connects will transfer the data to the target node.

The present invention relates to a method and system of distributing data to a target node in a network, said target node being arranged to be disconnectable from the network.

Future in-home network topologies are envisaged to comprise great amounts of nodes, wherein some nodes are stationary while others are mobile. A stationary node is a node which is always connected to the in-home network, for example a television set. A mobile node is a node which occasionally, but not always, is connected to the network. Of course, it is possible to disconnect a stationary node, such as a television set, from the network to which it is connected. However, in practice, a stationary node is seen as a node that is permanently connected to a network. It is further envisaged that future in-home networks comprise a middleware layer for interfacing software applications with network hardware. A middleware layer is generally implemented by means of software that functions as a conversion layer, for example to enable one application to communicate with another that either runs on a different platform or comes from a different vendor, or both. For instance, there are a number of middleware products that link a database to a Web server. This allows users to request data from the database, e.g. by using forms displayed on the Web browser. Further, there will be a data management middleware layer on top of the network middleware acting as a utility function to “shield” the applications from the complex nature of the network. Hence, rather than hard-coding data management functionality in each individual application, high level data management functionalities are added to the distributed middleware layer.

In the prior art, for an arbitrary stationary node to send data to a database on a mobile node, there are typically two options; the first is direct addressing and the second is broadcast-type transmission. When employing direct addressing, the stationary node (i.e. a source node), sends data to the address of the mobile node (i.e. a target node.) If the target node is not connected—or for some other reason unavailable—the data cannot reach the target node and is thus not delivered. In the network, there may be implemented an option for the source node to send the data to a central node, for instance a home-server, which caches the data until the target node connects to the network.

A problem associated with this direct-addressing method is that either the (mobile) target node has to connect directly to the home-server, or the home-server must find the target node, which may be connected to another network, and send the cached data to a connection point of the other network such that it can be sent to the target node. The procedure of forwarding data from one network to another may time-out if the target node is connected to networks for a short time period. Further, there may not even exist a central node in the network, which in fact is preferred, because such a node will pose a risk with respect to scalability and robustness in the network.

A problem with broadcast transmission is that it typically has a flooding effect on the network, since data not only is distributed to an intended target node, but also to other devices in the network, due to the nature of broadcast transmission. If during broadcast a mobile target node is not connected to the network, the data intended for the target node will be lost or possibly remain in the network, which puts a load on the network and requires resources at all network nodes.

An object of the present invention is to solve the above-described problems related to direct addressing of a mobile target node in a network and broadcast-type transmission of data to a mobile target node.

This object is attained by a method of distributing data to a target node in a network, said target node being arranged to be disconnectable from the network, in accordance with claim 1, and a system for distributing data to a target node in a network, said target node being arranged to be disconnectable from the network, in accordance with claim 9.

According to a first aspect of the present invention, there is provided a method comprising the steps of receiving data and a target address that designates a target node to which the data is to be communicated, distributing the data to network nodes to which the target node is connectable and transferring, when the target node connects to the network, the data to the target node from the network node to which the target node connects.

According to a second aspect of the present invention, there is provided a system comprising a source node arranged to receive data and a target address that designates the target node to which the data is to be communicated, which source node further is arranged to distribute the data to network nodes to which the target node is connectable. The system further comprises a distributing node arranged to transfer, when the target node connects to the network via the distributing node, the data to the target node.

A basic idea of the invention is to transfer data to a network target node, which is arranged to be disconnectable from the network, without having to directly address the target node or flood the network with the data by employing broadcast-type transmission. When a network source node wishes to transfer data to a target node, which at the time of data transfer is disconnected from the network, the source node distributes the data to network nodes via which the target node is connectable to the network. The source node may have received the data from an application, for example an Internet application, with which the source node interacts. The application is most likely unaware of whether the node is disconnectable from the network or not, or if it is connected to the network at the time of data transfer from the application to the network source node.

However, it is also possible that the source node distributes data which is “internal” to the network. For instance, the source node may be a multimedia computer which sends programming instructions to a portable DVD recorder to record tonight's television programs onto a DVD. Note that a node which is disconnectable from the network may be either stationary or mobile, as long as it actually can be connected/disconnected from the network. However, in practice, a disconnectable node is more likely to be mobile than stationary.

Now, when the source node distributes the data to the network nodes via which the target node is connectable to the network, the data is held at these nodes until the target node connects to any one of them. When the target node connects to any one of these nodes, the particular node with which the target node connects will transfer the data to the target node. The data to be transferred to a target node typically comprises an identifier, such that the data can be associated with the appropriate target node. In case one or more potential target nodes are disconnected from the network at the time of data transfer from the source node, the node which is to transfer the data to the target node must be assured that the data is transferred to the node for which it is intended, such that the data is not transferred to any disconnectable node that connects to the network. In practice, the data comprises two identifiers: one target node network address and one identifier for the particular target node.

The present invention is advantageous for a number of reasons. For instance, the data will be delivered to the target node, even though the target node is disconnected from the network at the time of data transfer from the source node; as soon as the target node connects to the network the data is be delivered. Further, problems associated with broadcast-type transmission in the prior art—such as network flooding—is avoided since the data preferably only is delivered to nodes with which the target node can connect to the network.

According to an embodiment of the present invention, when the target node has received the data, it transfers a data receipt acknowledgement to the node via which it is connected to the network. This data receipt acknowledgement is then preferably sent to the remaining nodes to which the data was sent, i.e. the remaining network nodes with which the target node is connectable. This has the advantage that the data must not be held by the nodes with which the target node is connectable after the data has been delivered to the target node, and hence frees resources in the network and relieves the network of load.

In a further embodiment of the present invention, the data receipt acknowledgement is transferred, if required, to the source node and on to the application from which the source node received the data that was communicated to the target node.

Further features of, and advantages with, the present invention will become apparent when studying the appended claims and the following description. Those skilled in the art realize that different features of the present invention can be combined to create embodiments other than those described in the following.

A detailed description of preferred embodiments of the present invention will be given in the following with reference made to the accompanying drawings, in which:

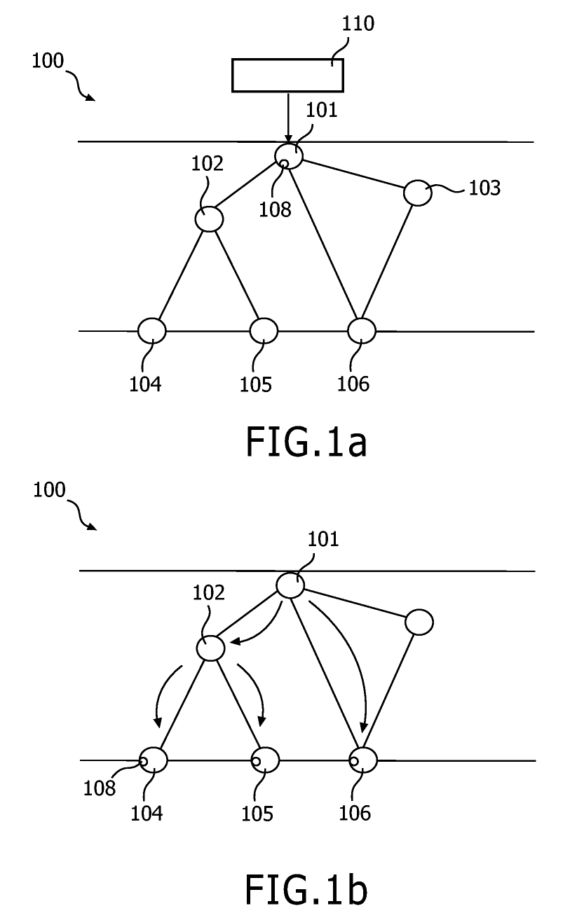

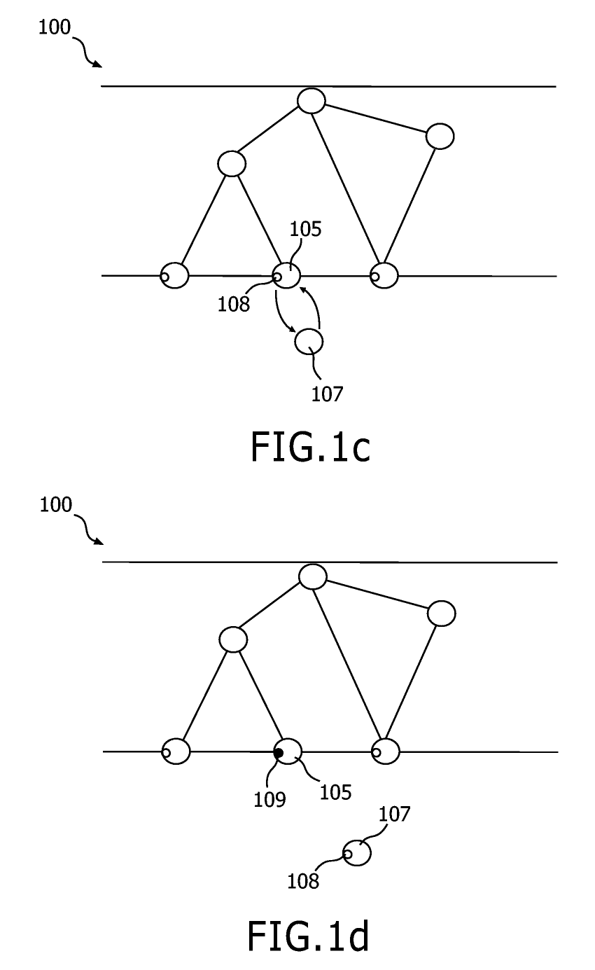

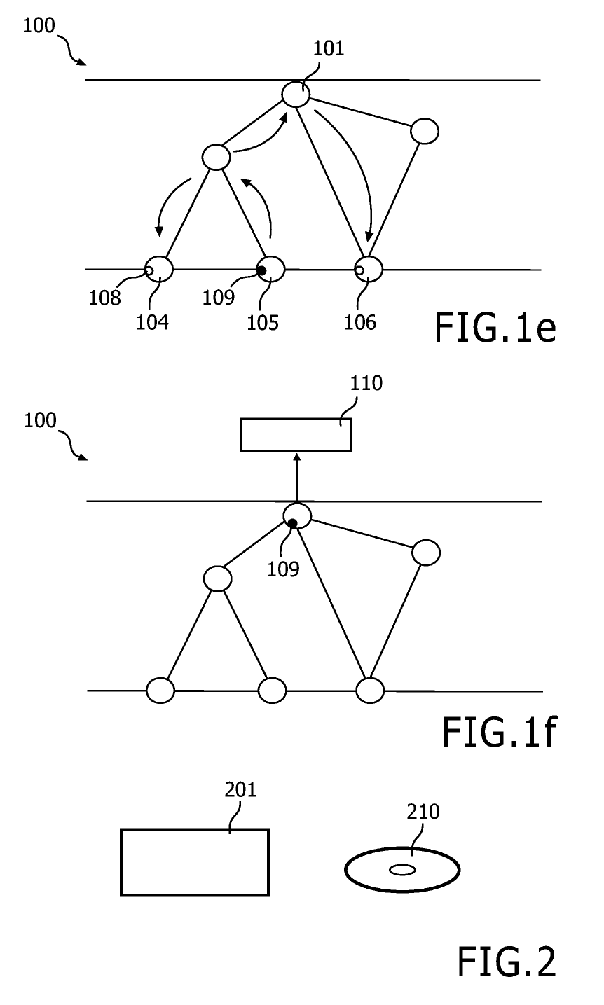

FIG. 1a shows an exemplifying network in which the present invention advantageously may be applied.

FIG. 1b shows an embodiment of the present invention in which a source node distributes target data to network nodes with which a target node can connect.

FIG. 1c shows an embodiment of the present invention in which target data is transferred from a network node to a target node.

FIG. 1d shows a target node disconnecting from a network.

FIG. 1e shows an embodiment of the present invention, in which an acknowledgement is distributed to network nodes to which the target data has been transferred.

FIG. 1f, shows an embodiment of the present invention in which an application is notified of delivery of target data.

FIG. 2, shows a device and computer program product.

In FIG. 1a, an exemplifying network is shown in which the present invention advantageously may be applied. An application 110 connects to and interacts with a network 100 comprising a number of nodes 101, 102, 103, 104, 105 and 106. For instance, the network 100 may be an in-home network and node 101 may be represented by a personal computer (PC), node 102 may be a television set, node 103 may consist of a video recorder, node 104 may be represented by a DVD player, etc. These types of devices are typically considered to be stationary. Further, the actual number of nodes in the network 100 shown in FIG. 1a is merely exemplifying. As is shown in FIG. 1a, the application 110 communicates with the network 100 via source node 101, which in this exemplifying embodiment is a PC. The application may enter the PC 101 via the Internet or via a CD player of the PC 101, if the application has been stored on a CD. The PC 101 receives an address—also known as a target address—of a mobile target device (i.e. a mobile target node) to which the application wishes to distribute data 108. Hereinafter, this data is referred to as target data.

Now, in FIG. 1b, the PC 101 distributes the data 108 to network nodes 104, 105 and 106. In an embodiment of the invention, the PC 101 translates or maps the target address into a number of target class addresses. A target class address is an address that designates a node on the network with which a mobile node may interconnect. Nodes in the exemplifying network 100 with which a mobile node may interconnect are nodes 104, 105 and 106. For instance, for each particular network node which occasionally is disconnected from the network, the respective address of the network nodes with which the disconnectable network node can connect to the network is stored at the source node 101. In this particular embodiment, the addresses of the network nodes 104, 105 and 106 are stored at the source node 101. The above mentioned target class addresses thus comprises these three network node addresses. When data is to be sent to the target node, the target node address is mapped to the target class addresses, and the data can be distributed to each network node 104, 105 and 106. Hence, node 101 sends the data 108 intended for the mobile target node—i.e. the target data—to the nodes designated by the target class addresses. The target data 108 is in the exemplifying network 100 distributed via node 102 to nodes 104, 105, but sent directly to node 106.

Note that the source node 101 may comprise a service, for instance a Domain Name Service (DNS). When a user (in the form of a node) does not know to which nodes a mobile node typically connects, the user may send the data with the target address to a Class Address Server (CAS), which dynamically translates the target address into a target class address.

In an exemplifying embodiment of the invention, the target class addresses may designate nodes on the network with which a mobile node recently has been connected to. For instance, the four network nodes with which the target node last has been connected.

With reference to FIG. 1c, when a mobile target node 107 (for which the target data is intended) connects to the network 100 at node 105, the target data 108 is transferred from node 105 to the mobile target node 107. Optionally, the target node provides node 107 with an acknowledgement 109 (shown in FIG. 1d). Hence, node 105 can be seen as a distributing node from which target data 108 is transferred to the target device 107.

In FIG. 1d, the mobile target node 107 disconnects from node 105 and hence the network 100. As can be seen, the target node 107 now has access to the target data 108.

FIG. 1e illustrates a further embodiment of the present invention, in which the acknowledgement 109 is distributed from node 105 to the nodes to which the target data was sent, i.e. nodes 104 and 106. Optionally, the acknowledgement is also sent to the source node 101 via which the target data 108 entered the network 100. Hence, it is no longer necessary for the nodes 104 and 106 to store the target data 108.

Possibly, as shown in FIG. 1f, the application 110 is notified of the delivery of the target data by means of the data receipt acknowledgement 109 received from the network 100.

FIG. 2 illustrates a device 201 for executing the method according to the invention and a computer program product comprising computer-executable instructions for causing a device to perform the steps of the method according to the invention.

It should be noted that the network nodes typically are equipped with microprocessors or some other appropriate processing means. For intercommunication to be possible, the network nodes are arranged with suitable interfaces that enable the communication. Further, the microprocessors typically execute software that is downloaded to the respective node and stored in a suitable storage area, such as a RAM, a Flash memory or a hard disk, in order to perform steps defined by the method of the present invention, which has been described in the various embodiments hereinabove. Further, in the exemplifying embodiments of the present invention described hereinabove in connection to FIGS. 1a-f, one single node which is disconnectable from the network is shown. It should be understood that a plurality of disconnectable nodes may be comprised in the network in which the present invention is applied.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of distributing data (108) to a target node (107) in a network (100), said target node being arranged to be disconnectable from the network, the method comprising the steps of:
receiving data and a target address that designates the target node to which the data is to be communicated;
distributing the data to network nodes (104, 105, 106) to which the target node is connectable; and
transferring, when the target node connects to the network, the data to the target node from the network node to which the target node connects.

2. The method according to claim 1, further comprising the step of:
receiving an acknowledgement (109) of data reception from the target node (107).

3. The method according to claim 2, wherein said acknowledgement (109) is distributed to the network nodes (104, 105, 106) with which the target node (107) is connectable.

4. The method according to claim 1, wherein said acknowledgement (109) is distributed to an entity (110) from which the data (108) and target address was received.

5. The method according to claim 4, wherein said entity (110) is an Internet application.

6. The method according to claim 1, wherein said step of distributing the data (108) to network nodes is preceded by the step of:
mapping the target address to a target class address, which target class address;
designates a network node (104, 105, 106) to which the target node (107) is connectable.

7. The method according to claim 6, wherein the mapping step is performed by extracting the target class address from a list of addresses to network nodes (104, 105, 106) to which the target node (107) is connectable.

8. The method according to claim 6, wherein a target class address designates a network node to which the target node (107) has been connected.

9. A system for distributing data (108) to a target node (107) in a network (100), said target node being arranged to be disconnectable from the network, the system comprising:
a source node (101) arranged to receive data and a target address that designates the target node to which the data is to be communicated, said source node further being arranged to distribute the data to network nodes (104, 105, 106) to which the target node is connectable; and
a distributing node (105) arranged to transfer, when the target node connects to the network via said distributing node, the data to the target node.

10. A computer program product (210) comprising computer-executable components for causing a device to perform the steps recited in claim 1 when the computer-executable components are run on a processing unit included in the device.

11. A source node (101) according to claim 9.

12. A distributing node (105) according to claim 9.
